(19) United States
(12) Patent Application Publication
(10) Pub. No.: US 2004/0258933 A1
(43) Pub. Date: Dec. 23, 2004

(54) Film having a coating with release properties

(76) Inventors: James P. Enniss, Martinsville, VA (US); Daniel G. Ballan, Martinsville, VA (US); Paula F. Richardson, Danville, VA (US)

Correspondence Address: PAUL E MILLIKEN, 9061 WALL STREET, NW, MASSILLON, OH, 44646-1676, US

(21) Appl. No.: 10/871,433

(22) Filed: Jun. 19, 2004

Related U.S. Application Data
(60) Provisional application No. 60/480,039, filed on Jun. 21, 2003.

(51) Int. Cl. B32B 27/36; B32B 9/00; B32B 27/30

(52) U.S. Cl. 428/480; 428/40.1; 428/448

(57) ABSTRACT

A transparent protective polymeric film 10 composite for laying over a surface, typically glass 120, the protective composite comprising a transparent polymeric film layer 11, typically PET, coated on at least one side with a transparent hard coat 12 containing at least 0.04% by weight of a release agent. The film composite hay be formed into a laminate 100 comprising a plurality of sheets of the film composite 110, the sheets being arranged in a stack such that adhesive 13 on one film composite sheet adheres to the hard coat 12 on a underlying sheet, and the release agent reduces the adhesion between the hard coat surface and the adhesive allowing the top sheet in the stack to be peeled off in turn as required.

### FIELD OF THE INVENTION

This invention relates to a coating for transparent polymeric film and in particular to film used in the manufacture of stacks of laminated clear film in which successive layers are removed after use to expose a new film layer.

### BACKGROUND OF THE INVENTION

It is well known to use a plurality of superimposed transparent plastic films to form a stack of films for use as a protective cover for either a motorcycle helmet or a car windshield, see for example from DE 3227366, U.S. Pat. No. 5,592,698 and U.S. Pat. No. 5,002,326. The different layers of film are removed successively as each film surface becomes dirty to expose a new clean film surface to improve visibility for a driver. Such systems are typically applied to motor cycle helmet visors and racing car windscreens.

In U.S. Pat. No. 5,002,326 and U.S. Pat. No. 6,388,813 the different layers of film are adhered to each other using a clear peel type adhesive on one side of the film which allows the one layer of film to adhere to the lower adjacent layer in the stack and be easily peeled from the lower layer. Even so, there is sometimes a problem when one film layer is removed from a lower film layer in that the adhesive does not always release properly from the underlying film layer leaving patches of adhesive on the newly exposed clean film layer. This both interrupts the visibility of the driver and provides a site to which dirt, insects and other foreign bodies can adhere. Another problem that may occur, when the upper side of the film is coated with a scratch resistant hardcoat, is the partial removal of the hardcoat.

The present invention provides a coating for a protective film which aids the release of adhesive and an improved coated film having a release surface.

### STATEMENTS OF THE INVENTION

According to a first aspect of the present invention there is provided a coating composition comprising a UV curable acrylate resin in a suitable solvent base and further including at least 0.04-10% by weight of siliconized acrylate resin.

The preferred acrylate resin is a hard coat as is described in U.S. Pat. No. 4,557,980 the contents of which are hereby incorporated into the present specification.

Preferably the acrylate resin is a mixture 40-50% of a pentaerythritol tetraacrylate and triacrylate mixture. The percentages are based on the total composition. A suitable material Sartomer SR-295 is available from Sartomer (Total).

Suitable solvents are at least one of acrylic acid, isopropyl alcohol and MEK

According to another aspect of the present invention there is provided a transparent protective polymeric film composite for laying over a surface, for example glazing, the protective composite comprising a transparent polymeric film layer coated on at least one side with a transparent hard coat containing at least 0.04% by weight of a release agent which reduces the adhesion between the exposed surface coating and an adhesive layer applied thereto.

The release agent is preferably a siliconised acrylate. A suitable material is Ebecryl 1360 available from UCB Chemical Corporation.

The film may comprise one of polycarbonate, acrylic, polypropylene and PET, the preferred film being PET. The film is preferably a PET (polyethylene terephthalate) film about 4 mil (0.1 mm) thick which may contain a UV absorbing material as is disclosed in U.S. Pat. No. 6,221,112.

Glazing includes any suitable transparent sheet material which may be used for motor cycle helmet visors, vehicle windscreens, aircraft canopies and windscreen and windows, PC Monitor Screens etc. and which include glass, acrylic sheet, polyester sheet, polycarbonate sheet.

The coating remains relatively clear with haze of 1% or less and with high gloss having a 60 degree gloss of over 100 gloss units

In the preferred embodiment the hard coat has a thickness of between 1.5-2.0 microns. The hardcoat may also contain a nanoparticle dispersion therein. Nanoparticles should have a size of less than 0.1 microns diameter.

The other surface of the polymeric film may be coated in a releasable clean peel adhesive, preferably Gelva GMS 3149 which in use adheres to the film layer but releases from said hard coat. The adhesive may be covered with a release liner. Such a composite provides a sacrificial layer which protects an underlying surface from damage due to abrasion by dirt etc. and in some applications may also act as an anti-graffiti film.

A further laminate comprises at least one sheet of film composite overlying a base layer which is adhered to the other side of the polymeric film layer, the base layer comprising a solar control film, an example of which is disclosed in U.S. Pat. No. 6,416,872 and U.S. Pat. No. 6,007,901. Such a film has a high visible light transmission, typically at least 70%, and reflects IR light. The bottom surface of the base layer will be coated in an adhesive and covered with a release liner. Such a laminate is useful in the application to car windscreens, or other glazing, where heat sensitive items or components may be located behind the glazing, for example on a car dash board or facia panel.

According to yet another aspect of the present invention there is provided a laminate comprising a plurality of sheets of a transparent polymeric film composite each film composite comprising a transparent polymeric film layer coated on one side with a transparent hard coating containing at least 0.04% by weight of a release agent and which is coated on the other side in a releasable clean peel adhesive, the arrangement being such that the adhesive on one sheet adheres to the hardcoat on a underlying sheet and the release agent reduces the adhesion between the hardcoat surface and an adhesive layer applied thereto as compared with the same hardcoat having no release agent therein.

The adhesive layer of the bottom sheet of said laminate may be covered with a release liner.

### DESCRIPTION OF THE DRAWINGS

The invention will be described by way of example and with reference to the accompanying drawings in which:

FIG. 1 is a cross-section through a protective film composite according to the present invention;

FIG. 2 is a cross-section through a laminate according to the present invention shown in situ on glazing; and

FIG. 3 is a cross-section through a second laminate also shown in situ on glazing.

### DETAILED DESCRIPTION OF THE INVENTION

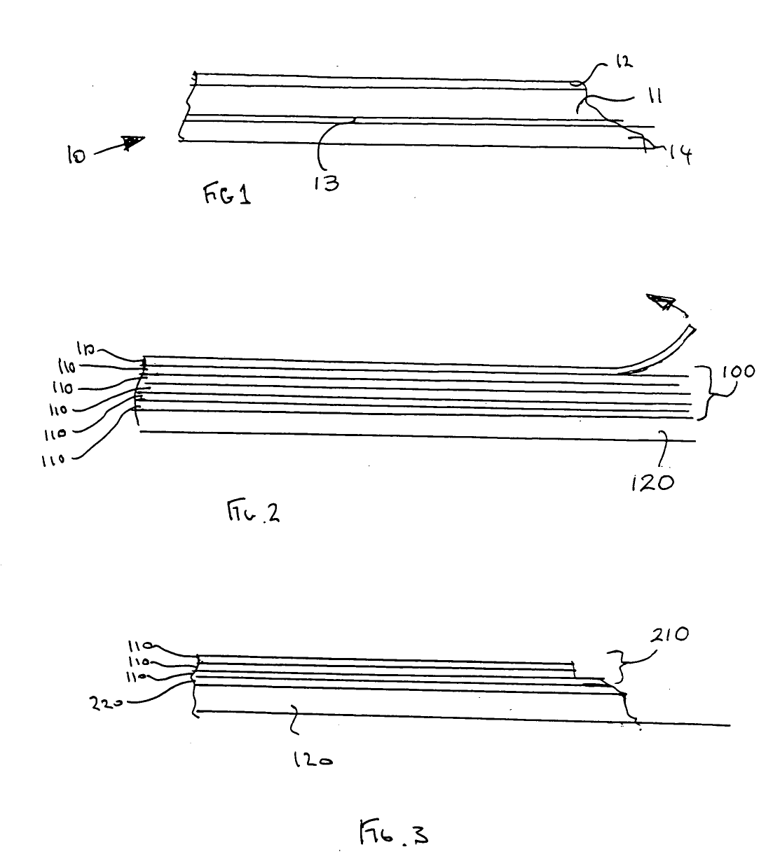

With reference to FIG. 1 there is shown a protective film composite 10 comprising a suitable transparent polymeric film layer 11 coated on one side with a scratch resistant hardcoat 12 and on the other side with an adhesive layer covered with a protective release liner 14.

The adhesive layer 13 is an easy peel type adhesive for example Gelva GMS 3149 which adheres preferentially to the film. The release liner 14 may comprise a polyethylene coated paper, or a silicone release coating which can be peeled from the adhesive leaving the adhesive layer on the film 11.

A suitable transparent film is a polyester film, preferably a polyethyleneterephthalate (PET) film treated with a UV absorber as described in U.S. Pat. No. 6,221,112B so as to absorb up to 99% of UV radiation. A suitable PET film is DuPont Teijin Films' Melinex 454 or LJX 112.

The hard coat 12 is a UV cured acrylate based resin which is formed from a liquid composition which is applied to the surface of the PET film by any suitable process. The coating composition may comprise a resin and solvent base as is described in U.S. Pat. No. 4,557,980. The coating used for hard coat layer 12 is formed from a liquid composition which is applied to the surface of the PET film by a reverse gravure process. The coating composition may comprise a resin and solvent base as is described in U.S. Pat. No. 4,557,980 and typically comprise the constituents of Table 1 below.

TABLE 1

| | |
|---|---|
| Acrylate resin | 30-75% |
| Acrylic Acid | 0-45% |
| Solvent | 0-40% |
| Photoinitiator | 2.4-5.0% |
| Siliconised Arylate | 0.04-10% |

The percentages are weight percentages of the coating mixture.

Sample coating were made to the composition given in table 2:

TABLE 2

| | |
|---|---|
| Acrylate resin | 50-60% |
| Acrylic acid | 35-45% |
| Solvent | 0-10% |
| Photointiator | 4.0-5.0% |
| Siliconised Acrylate | 0.04-0.7% |

The percentages are weight percentages of the coating mixture.

Suitable siliconised acrylates are Ebecryl 1360, and EB350 available from UCB Chemical Corporation.

The acrylate resin is preferably a mixture of pentaerythritol tetraacrylate and triacrylate mixture. A suitable material is Sartomer SR-295 available from Sartomer (Total).

Suitable solvents, in addition to the acrylic acid which acts as a solvent, are isopropyl alcohol and MEK (methylethyl ketone).

The ingredients for the coating are mixed together. The siliconised acrylate may be diluted in 50% MEK (that is 50% based on the weight of siliconised acrylate) prior to addition. The stable mixture is stored for later use. The clear stable coating composition is applied using a reverse gravure process in a thickness of about 2-6 microns and coats evenly and levels smoothly. After application to the PET film the coating remains stable until drying, and UV curing after drying.

The final cured dried hard coat has a thickness of about 1.5-1.7 microns.

The hard coat 13 may also include a dispersion of 20-25% by weight of nanoparticles of silica in the UV-cured polymeric resin. Nanoparticles have a particle size of 0.1 microns or less. The nanoparticles remain stably dispersed during film formation, drying and UV curing and do not make any significant contribution to haze or reduction in gloss. The nanoparticles are added to increase hardness and scratch resistance if required.

The hard coat has the following typical physical properties:

Haze<1%,

Gloss 60 degree gloss 100 gloss units

Scratch resistant to 0000 Steel Wool

The Gloss was measured using a Byk Gardner Glossmeter.

Abrasion<12%.

The haze was measured using a Hunter Laboratories Ultrascan XE and calculated according to (Diffuse Transmittance/Total Transmittance) X 100 over a light range of 380-780 nm.

The scratch test is a subjective test in which the coating is rubbed with steel wool and viewed for scratching.

The abrasion test uses a Taber Abrader in accordance with ASTM D1044-93 using a CS10 wheels each loaded with 1 kg. The results are quoted in an increase in haze after 100 cycles.

The adhesion of the film composite to an underlying film composite must lie between particular limits. The adhesion must be sufficient to prevent easy release of the film composite for example during driving at race speeds where the film composite is used as a windscreen protector, but must not be so adhesive as to damage the hard coat.

The adhesion of the film composite 10 to a second underlying film composite 10 was tested for various film composites made in accordance with Table 2. Samples were tested for clean removal without damage to the hard coat of the underlying film by peeling a 2.54 cm (1 inch) width of strip from the underlying hard coat. As a control the strip was also peeled from hard coat having a similar formulation to that shown in Table 2 but which did not contain the siliconized acrylate.

For hard coat containing 0.07-1.25% siliconized acrylate when dried, the release force for the peelable adhesive was 25-30 grams/inch width (25.4 mm) and for the control material 87 grams/inch width (2.54 mm). The addition of the siliconized acrylate creates a low surface energy which enables an overlying sheet to be easily and quickly peeled from the hard coat. It is thought that the siliconized acrylate migrates to the surface so that its effect levels off after minimal additions of the siliconized material.

The low surface energy also renders the hard coat surface resistant to pens, markers etc. creating an anti-graffiti film composite.

Further formulations based on Table 2, but outside of the scope of the present invention, were also formulated using about 7% by weight of acrylated silicone resin RC902 (available from Goldschmidt Chemical Corporation, a division of Degussa) instead of siliconized acrylate, for tests for release properties. This chemical appeared to interfere with the curing of the hardcoat. It would therefore appear that the release agent must contain an acrylate spine as opposed to a silicone spine.

In a further embodiment of the invention, as shown in FIG. 2, a laminate 100 comprises a plurality of sheets of film composite 110, in this example 6 sheets, but any number of sheets of film composite as is desired, may be used to form a stack of superimposed sheets. The laminate 100 is shown adhered to a vehicle windscreen 120.

Each film composite 110 in the stack comprise a clear PET film layer 11 having a hard coat 12 on one side and an adhesive layer 13 on the other side as is shown in FIG. 1. The sheets are stacked so that the hard coats 12 face away from the glazing 120 and the adhesive layer 13 on one sheet adheres to the 12 hard coat of an underlying sheet. The use of the release agent in the hard coat enables the upper sheets of film composite 110 to be easily removed by peeling one sheet at a time from the stack.

A further embodiment is shown in FIG. 3 in which a second film laminate 210 comprises at least one sheet of film composite 110, in this case three sheets are shown but any number of sheets of composite 110 may be used as is desire, and a base layer 220 which lies adjacent the glazing 120. The base layer 220 comprises a suitable solar control film as is described in U.S. Pat. No. 6,416,872 and U.S. Pat. No. 6,007,901 and is typically a film having a high visible light transmission, above 70% VLT, and high reflectance in the infra red light range.

In an alternative arrangement the base layer may be dyed to reduce glare.

What is claimed is:

1. A coating composition comprising a UV curable acrylate resin in a suitable solvent base and further including at least 0.04-10% by weight of siliconized acrylate resin.

2. A coating as claimed in claim 1 wherein the acrylate resin is a mixture 40-50% of a pentaerythritol tetraacrylate and triacrylate mixture, the percentages are based on the total composition.

3. A coating as claimed in claim 1 wherein a suitable solvent comprises at least one of acrylic acid, isopropyl alcohol and MEK.

4. A transparent protective polymeric film composite for laying over a surface, the protective composite comprising a transparent polymeric film layer coated on at least one side with a transparent hard coat containing at least 0.04% by weight of a release agent which reduces the adhesion between the exposed hard coat surface and an adhesive layer applied thereto.

5. A composite as claimed in claim 4 wherein the release agent is a siliconized acrylate.

6. A composite as claimed in claim 4 wherein the film layer comprises PET (polyethylene terephthalate) film.

7. A composite as claimed in claim 6 wherein the PET film contains a UV absorbing material.

8. A composite as claimed in claim 4 wherein the hard coat is substantially clear with haze of 1% or less and with high gloss having a 60 degree gloss of over 100 gloss units.

9. A composite as claimed in claim 4 wherein the other surface of the polymeric film layer is coated in a releasable clean peel adhesive which in use adheres to the film but releases from said hard coat.

10. A composite as claimed in claim 9 wherein the adhesive is covered with a release liner.

11. A transparent protective polymeric film composite for laying over a surface, the protective composite comprising a transparent PET film layer which includes a UV absorber and is coated on at least one side with a transparent UV cured acrylate resin hard coat containing at least 0.04% by weight of siliconized acrylate resin to reduce the adhesion between the exposed hard coat surface and an adhesive layer applied thereto.

12. A laminate comprising at least one sheet of film composite as claimed in claim 4 overlying a base layer which is adhered to the other side of the polymeric film layer, the base layer comprising a solar control film.

13. A laminate as claimed in claim 12 wherein the solar control film is a heat mirror having a high visible light transmission of at least 70%, and which reflects IR light.

14. A laminate comprising a plurality of sheets of a transparent polymeric film composite each sheet stacked one on another, each film composite comprising a transparent polymeric film layer coated on one side with a transparent hard coat containing at least 0.04% by weight of a release agent and which is coated on the other side in a releasable clean peel adhesive, the arrangement being such that the adhesive on film composite adheres to the hard coat on a underlying film composite, and the release agent reduces the adhesion between a hard coat surface and an adjacent adhesive layer applied thereto as compared with the same hard coat having no release agent therein.

15. A laminate as claimed in claim 14, wherein the adhesive layer of the bottom sheet of film composite of said stack is covered by a release liner.

16. A laminate as claimed in claim 14, wherein the bottom sheet of film composite of said stack is adhered to a solar control film composite.

17. A laminate comprising a plurality of sheets of a transparent PET film composite, each sheet stacked one on another sheet, each film composite comprising a transparent PET film layer containing a UV absorber and being coated on one side with a transparent hard coat containing at least 0.04% by weight of siliconized acrylate and coated on the other side in a releasable clean peel adhesive, the arrangement being such that the adhesive on film composite adheres to the hard coat on a underlying film composite, and the release agent reduces the adhesion between a hard coat surface and an adjacent adhesive layer applied thereto as compared with the same hard coat having no release agent therein, the bottom sheet of film composite of said stack is adhered to a solar control film composite layer which permits transmission of visible light and reflects IR light.
